(19) United States
(12) Patent Application Publication
(10) Pub. No.: US 2022/0344922 A1
(43) Pub. Date: Oct. 27, 2022

(54) A COMBINED CABLE TROUGH AND WALKWAY

(71) Applicant: TROJAN SERVICES LIMITED, Hove (GB)

(72) Inventor: Stewart WELLENS, Hove (GB)

(21) Appl. No.: 17/596,588

(22) PCT Filed: Jun. 14, 2019
(86) PCT No.: PCT/GB2019/051648

§ 371 Date: Dec. 14, 2021

(51) Int. Cl. H02G 9/04; E01B 2/00

(52) U.S. Cl. CPC H02G 9/04; E01B 2/00

(57) ABSTRACT

Disclosed is a trunking section for carrying cables, wherein the trunking section comprises mutually interlocking parts allowing two trunking sections to be semi-permanently connected together, wherein the trunking section comprises at least one divider to partition an interior of the trunking section into at least two longitudinal channels, separated by the at least one divider.

The present invention concerns a combined cable trough, or trunking section, and walkway for use primarily in a railway environment for routing and carrying communication and/or power cables and which also has a function as a safe level walkway beside a railway track.

Railway tracks are frequently laid on uneven ground which has been topped off with ballast, which is essentially rubble. When railway technicians and engineers are required to work on the railway, they often have to walk significant distances alongside the railway track over this ground. The unevenness of this ground poses a problem for the workers and makes it difficult to transport tools and equipment if there is no corresponding access roadway.

Additionally, railway tracks, often in urban settings, are laid into roadways (for light rail or tram applications) or laid on elevated sections, above roads and other traffic.

There are often regulations in place that dictate certain requirements for provision of a safe and level walkway alongside railway tracks. Currently, such walkways tend to consist of flattened and compressed earth and are not generally suitable to transport tools and equipment. In wet weather, such walkways can become slippery and dangerous.

At the same time, there is often a requirement to provide routing for cables alongside railway tracks. These cables can be used for transmitting power around the railway network, or for signalling and communication purposes. Sometimes, third parties lease space in the routing system and make use of the extensive railway network to route their own communication cables around the country.

Accordingly, there is a need to provide a system for implementing walkways to run alongside railway tracks in a quick, easy and economic manner, which can be easily retrofitted to existing railway infrastructure.

Embodiments of the present invention aim to address problems in the prior art, and other problems whether mentioned explicitly herein or not.

According to a first aspect of the present invention, there is provided a trunking section for carrying cables, wherein the trunking section comprises mutually interlocking parts allowing two trunking sections to be semi-permanently connected together, wherein the trunking section comprises at least one divider to partition an interior of the trunking section into at least two longitudinal channels, separated by the at least one divider.

In an embodiment, the divider is arranged such that the at least two longitudinal channels are of unequal width.

In an embodiment, the divider is arranged to provide two longitudinal channels, arranged to carry power and signalling cables respectively.

In an embodiment, a lap joint is formed between adjacent sidewalls of connected trunking sections.

In an embodiment, there is further provided a lid comprising two lid elements, each lid element arranged to close at least one longitudinal channel.

In an embodiment, each lid element is supported on a first edge by a sidewall of the trough and on a second edge by the divider.

In an embodiment, each lid element comprises at least one projection arranged to engage with a complementary recess in the divider.

In an embodiment, each lid element is provided with a plurality of fastening apertures to accommodate fasteners to secure each lid element to the trunking section.

In an embodiment, each lid element is provided with a substantially non-slip surface.

In an embodiment, there is further provided a fascia panel arranged to attach to an outer sidewall of the trunking section.

In an embodiment, the trunking section is unitary and formed from a plastics material in an injection moulding process.

According to the present invention there is provided an apparatus and method as set forth in the appended claims. Other features of the invention will be apparent from the dependent claims, and the description which follows.

For a better understanding of the invention, and to show how embodiments of the same may be carried into effect, reference will now be made, by way of example, to the accompanying diagrammatic drawings in which:

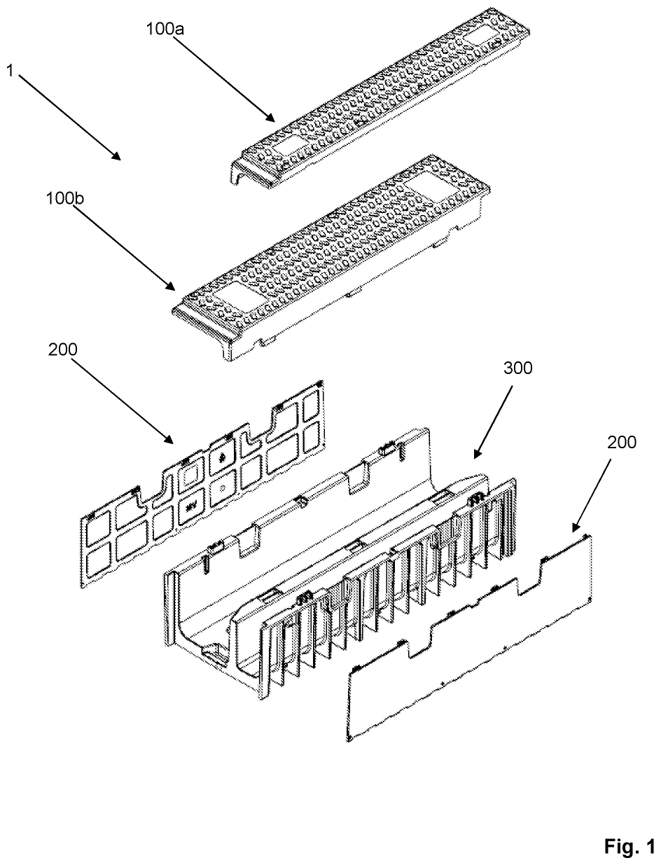

FIG. 1 shows a perspective exploded view of an embodiment of the invention;

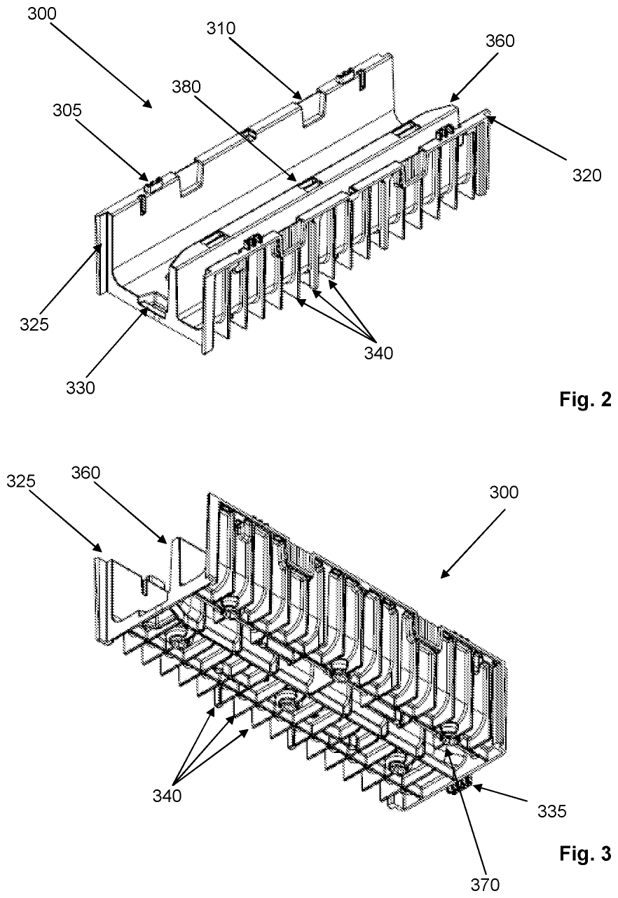

FIG. 2 shows a perspective view of a trough element of an embodiment of the present invention;

FIG. 3 shows an underside view of a trough element of an embodiment of the present invention;

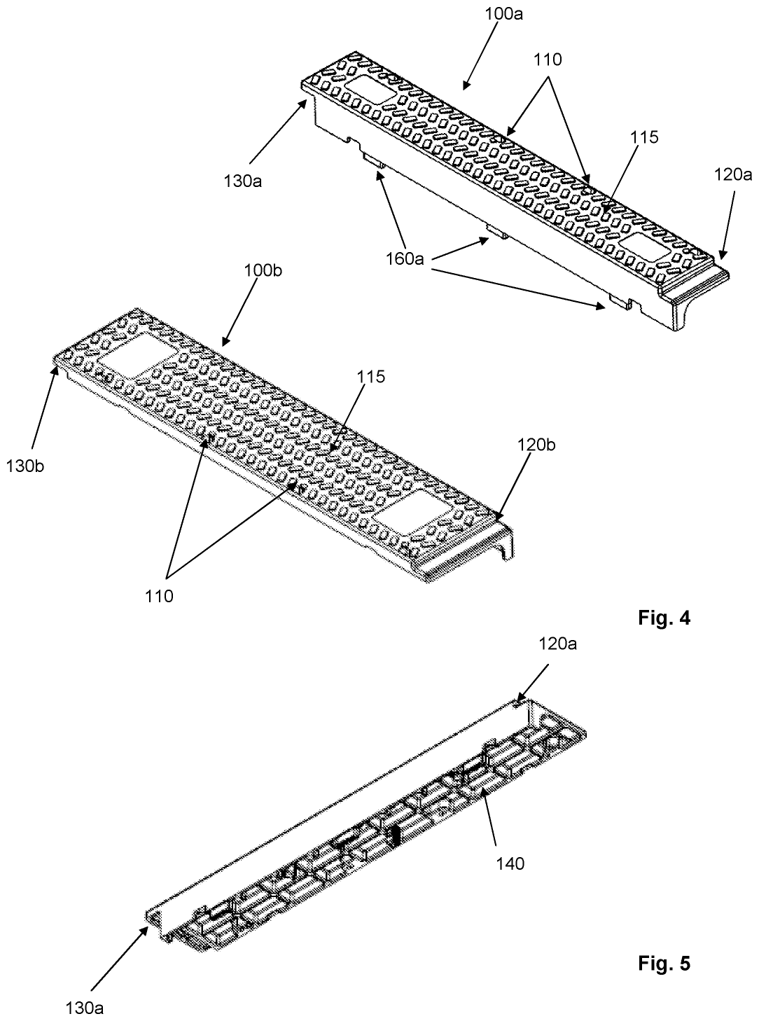

FIG. 4 shows a perspective view of two lid elements of an embodiment of the present invention;

FIG. 5 shows an underside view of a lid element according to an embodiment of the present invention;

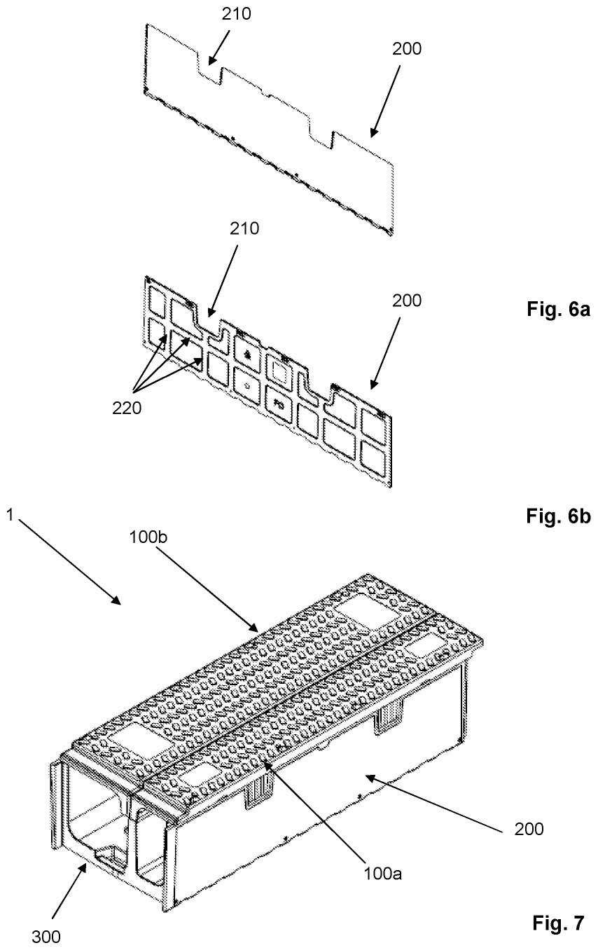

FIGS. 6a and 6b show front and back views, respectively, of a fascia panel according to an embodiment of the present invention;

FIG. 7 shows a perspective view of an assembled unit according to an embodiment of the present invention; and

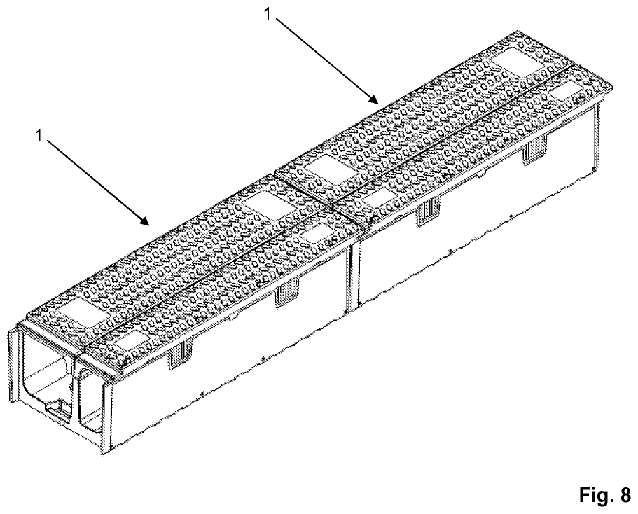

FIG. 8 shows two of the units of FIG. 7 connected together in use.

FIG. 1 shows a perspective view of an assembly or unit 1, comprising a trough 300 together with lid 100. In one use scenario, the trough 300 arranged in use to be wholly or partially buried alongside a railway track. Alternatively, it can be arranged to stand atop a supporting surface in certain implementations. In such circumstances, fascia panels 200 may be attached to exposed sidewalls of the trough 300.

Referring to FIGS. 2 and 3, the trough 300 is generally U-shaped and, in use, a plurality of such troughs 300 are arranged end to end to carry cables associated with the railway system or otherwise. These may be power cables, signalling cables, data communication cables or cables carried for third parties, such as fibre-optic data cables.

The cable trough 300 is constructed from a plastics material. The plastics material comprises a polymer which is preferably recycled. In a preferred embodiment the preferred polymer is a polyolefin. The trough component 300 is preferably constructed using an injection moulding process as a single component. By use of a plastics material, the weight of the trough or trunking section is kept at a level where it may be carried by a single person, greatly easing work with the units on-site

The other components, to be described in more detail later, are also constructed from the same materials, using the same injection moulding process.

The generally U-shaped channel formed by the trough 300 is shown in FIG. 2. The channel is formed by a base and two generally upright sidewalls, which are each provided with a plurality of reinforcing ribs 340. These are arranged externally and extend from the trough. As well as providing additional rigidity, the ribs 340 assist in anchoring the trough 300 in the ground, if it is installed in a scenario where it is at least partially buried, either in earth, gravel or hardcore.

Along an upper edge of each sidewall is at least one lid-engaging projection 305. These are arranged to engage with a complementary recess in the lid 100.

Located towards an upper portion of each sidewall is at least one knockout panel 310. This is arranged so that cables running in the trough can be provided with an exit to couple to trackside equipment or to another conduit for onward transmission elsewhere. The knockout panel 310 is arranged to have a thickness somewhat less that the surrounding material such that it can be removed with e.g. a hammer blow or by use of a pair of snips.

Arranged longitudinally in the U-shaped trough is a divider 360, which divides the trough into two longitudinal channels. In the present embodiment, the two channels so formed are of unequal size. The larger channel is provided to carry power cables, which are relatively larger, and the smaller channel is provided to carry signalling cables, which are relatively smaller. The signalling cables may be electrical or fibre-optic cables.

In other embodiments, more than one divider 360 may be provided, as required.

The divider is also provided to support the lid elements 100a, 100b, to be described later.

In order to connect two troughs 300 end to end, as required to create a suitable length of troughing, there are two distinct features of the trough 300 which facilitate this. Note that in practice, many hundreds or thousands of troughs 300 may form an installation. At opposed end of the trough are coupling projection 335 and coupling receiver 330. Coupling projection 335 may be considered as a male part and coupling receiver 330 may be considered as a female part. As such, the troughs may only be joined in one orientation, male to female.

The male 335 and female 330 parts interconnect snugly, but allow a small amount of relative rotation therebetween (just a few degrees) to accommodate bends in the track along which the troughs are fitted.

In addition to the male 335 and female parts, the exposed ends of the sidewalls 320, 325 assume a form of lap joint. In other words, the end of the trough with the coupling projection 335, has exposed sidewall ends 320 which inter-engage with the exposed sidewall ends 325 of the opposed end such that a form of lap joint is created and thereby access to an interior of the trough is not permitted once the lid is fitted, due to the overlapping of the portions 320, 325.

The troughs can be fastened to the supporting surface by applying a suitable fastener, such as a screw of bolt through apertures 370 provided in the base of the trough 300.

FIG. 4 shows two lid elements 100a, 100b which, together, form the lid which closes the trough 300, in use. The lid is provided in two sections, since the interior of the trough is divided into two longitudinal channels, as set out previously. The wider of the lid elements 100b is arranged to cover the larger channel which typically carries power cables. The narrower lid element 100a is arranged to cover the smaller channel which typically carries signalling cables.

The two lid elements 100a, 100b are arranged to be individually fitted and removable, so that just one of the two channels in the trough 300 can be exposed. It may be unsafe to expose the power cables in the larger channel and yet there may be occasions where access is required to the signalling cables, without exposing the power cables. By means of the segregation of the cables and the provision of separate lid elements 100a, 100b, access to the power cables can be prevented.

In order to support the two lid elements 100a, 100b in use, the divider 360 acts to support one long edge of each lid elements, while the other long edge is supported on an outer edge of the trough 300.

As can be seen in FIG. 4, a series of projections 160a are provided on a lower edge of lid element 100a. A similar series exists on lid element 100b in corresponding positions. When a lid element 100a is placed in-situ to close the trough, projections 160a align and engage with complementary recesses 380 in the divider 360. This ensures that the lid element is correctly aligned and ensures a good and secure fit. The same is true for lid element 100b which is similarly fitted.

Provided along the outer long side of each lid element 100a, 100b are a plurality of coupling apertures 110. These are arranged to lie above complementary fastening receivers in the trough sidewalls. A screw or bolt is fitted through each aperture 110 and engages with the complementary recess to fasten the lid element in place. The screw or bolt may be provided in the form of a security screw or bolt having a non-common head such that a special tool is required to fit or remove it. This can provide extra security and deter interference with the contents of the trunking section.

Indeed, separate types of fixings may be provided for each lid element, so that extra security is provided for one of the channels defined in the trough.

Each short end of the lid element is provided with complementary fittings such that the lid element 100a, 100b can only be fitted in one orientation such that a lap joint is formed, in much the same way as described previously in respect of the ends of troughs 300. Features 120a, 130a, 120b and 130b are best viewed in FIG. 4.

FIG. 5 shows the matrix-like structure 140 on the underside of the lid element 100a. A similar arrangement is used for lid element 100b. This matrix 140 takes the form of perpendicular intersecting ribs, which extend from the underside of the lid element and provide mechanical strength to the lid element, which should be able to withstand the weight of at least a person walking thereon and preferably the weight of tools or equipment also.

In an embodiment where more than one divider 360 is provided, then a lid element may cover more than one longitudinal channel formed by the divider. For instance, one channel may be provided for power cables, which is closed by one lid element, and two channels for signalling cables may be provided by a further divider, both of which channels are closed by a single further lid element.

FIGS. 6a and 6b show, respectively, front and rear views of fascia panels 200. These are arranged to be attached to exposed external sidewall surfaces in certain embodiments of the invention. As mentioned previously, the trough 300 may be buried in the ground, in which case, the reinforcing ribs 340 assist in anchoring the trough in place. However, in some installations, the troughs 300 are arranged to sit atop a supporting surface and are thus fully visible. It may be desirable, in such cases, to attach fascia panels 200 to lessen the visible impact of the troughs and/or make them appear more attractive. The panels 200 may be provided in one or more colours or designs arranged to complement their settings.

The rear of the fascia panel is provided with an interconnected matrix of reinforcing ribs 220, which project only a short distance from the surface, but which provide sufficient additional rigidity.

The fascia panels are arranged to click into position by means of suitable fasteners which engage with features on the surface of the trough, such as the ribs 340. Alternatively, the panels may be secured in place using a screw or by means of adhesive.

The fascia panels include a notched section 210 which aligns with the knockout panel 310.

FIG. 7 shows a perspective view of a fully assembled unit 1, comprising a trough 300, two lid elements 100a, 100b and two fascia panels 200. In practice, a plurality of troughs 300 would be placed in situ before the lid elements 100a, 100b are added to complete the installation.

FIG. 8 shows an assembly comprising two troughs 1, laid end to end. In reality, many hundreds or even thousands of such troughs may be provided.

Advantageously, embodiments of the invention may be provided to be buried alongside a rail track, or to sit proud of a supporting surface, particularly on an elevated concrete structure.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A trunking section for carrying cables, wherein the trunking section comprises mutually interlocking parts allowing two trunking sections to be semi-permanently connected together, wherein the trunking section comprises at least one divider to partition an interior of the trunking section into at least two longitudinal channels, separated by the at least one divider.

2. The trunking section of claim 1 wherein the divider is arranged such that the at least two longitudinal channels are of unequal width.

3. The trunking section of claim 2 wherein the divider is arranged to provide two longitudinal channels, arranged to carry power and signalling cables respectively.

4. The trunking section of claim 1, wherein a lap joint is formed between adjacent sidewalls of connected trunking sections.

5. The trunking section of claim 1, further comprising a lid comprising two lid elements, each lid element arranged to close at least one longitudinal channel.

6. The trunking section of claim 5 wherein each lid element is supported on a first edge by a sidewall of the trough and on a second edge by the divider.

7. The trunking section of claim 6 wherein each lid element comprises at least one projection arranged to engage with a complementary recess in the divider.

8. The trunking section of claim 5, wherein each lid element is provided with a plurality of fastening apertures to accommodate fasteners to secure each lid element to the trunking section.

9. The trunking section of claim 5 wherein each lid element is provided with a substantially non-slip surface.

10. The trunking section of claim 1, further comprising a fascia panel arranged to attach to an outer sidewall of the trunking section.

11. The trunking section of claim 1 wherein the trunking section is unitary and formed from a plastics material in an injection moulding process.

12. The trunking section of claim 6, wherein each lid element is provided with a plurality of fastening apertures to accommodate fasteners to secure each lid element to the trunking section.

13. The trunking section of claim 7, wherein each lid element is provided with a plurality of fastening apertures to accommodate fasteners to secure each lid element to the trunking section.

14. The trunking section of claim 8, wherein each lid element is provided with a substantially non-slip surface.
